(19) United States
(12) Patent Application Publication
(10) Pub. No.: US 2012/0107543 A1
(43) Pub. Date: May 3, 2012

(54) System for Providing an Informative Temporary Tattoo for a Traveler

(76) Inventor: Lori Pickett, Jasper, GA (US)

(21) Appl. No.: 12/912,989

(22) Filed: Oct. 27, 2010

(51) Int. Cl. B32B 33/00

(52) U.S. Cl. 428/41.8

(57) ABSTRACT

Disclosed is a system providing both personal and medical information regarding a traveler using a temporary tattoo. The temporary tattoo is applied to the wearer's body at an appropriate place to indicate a medical condition or emergency contact information. The temporary tattoo can also provide personal information in multiple languages and entered by the wearer.

### TECHNICAL FIELD

The present invention relates generally to a system for providing personal information about a traveler and in greater detail the present system conveys both personal and medical information via a temporary tattoo applied to the traveler which can be customized to provide additional information.

### BACKGROUND

People are sometimes subjected to conditions that require them to undergo emergency medical treatment. Such treatment may typically involve the administration of blood and/or drugs, or may require other procedures that could cause further harm to the person if certain precautions are not taken. For instance, it essential to know the blood type of persons receiving blood transfusions, and to know if that person is allergic or otherwise experiences adverse reactions to certain drugs.

Further, medical devices or prostheses, such as a heart pacemaker, or contact lenses or the like may be worn by the person being treated. In addition, there may be aspects of that person's medical history which are essential to proper treatment, whereby consultation with that person's personal physician would be desirable in order to obtain the medical history or other data useful in the treatment of the person.

In many instances, the person who must receive emergency medical treatment is either unconscious or otherwise unable to be of assistance to rescue and/or medical personnel. Thus, the information noted above, and essential to the treatment of the person, may not be readily and quickly obtainable from the person or from normal channels of such information.

To solve this problem, various devices are typically employed in the prior art, including cards that are adapted to be carried in a person's wallet or pocketbook, or I.D. tags and the like that may be worn about the neck of the person. Miniaturized viewers have also been devised, carrying medical and other personal information on a small piece of microfilm that may be read through a lens provided on the device.

However, there has not been provided a solution for a user who travels and needs particular or specialized information to be conveyed to emergency caregivers on a temporary basis. When traveling, a tourist often needs to convey different information to emergency workers than to such workers when home. For example, a traveler may need to provide where one is straying and provide such information in the language of that country. Thus, what is needed is a method and system for providing temporary information related to a traveler in emergency situations.

### SUMMARY

The present system and method can provide both personal and medical information regarding a traveler by the use of a temporary tattoo. The temporary tattoo can be applied to a wearer's body at an appropriate place to indicate a medical condition needing certain action or personal and emergency contact information. The temporary tattoo in a further embodiment may contain verbiage in a language other than the wearer's to convey information to emergency workers in foreign countries. The temporary tattoo is typically applied using an adhesive and printed on a substrate.

In greater detail, the system provides for an informative temporary tattoo to be applied to a wearer's skin when the wearer is traveling to convey information related to the wearer. The system includes a decal substrate material and an insignia releasably disposed over the substrate material. The insignia conveys information related to the wearer. A pressure sensitive adhesive over and in register with the insignia is included with a removable release sheet over the adhesive.

The insignia may also include verbiage and in one embodiment the verbiage is not written in English. In a further embodiment the verbiage includes a language foreign to the wearer. Additionally, the verbiage may be in the native language of the country traveled by the wearer of the temporary tattoo.

Additionally, the insignia may also include information regarding a medical condition of the wearer. The insignia information may include an indication regarding the wearer's nation of origin. The insignia can also include instructions for emergency personal.

In a further embodiment of the present system, the temporary tattoo includes a portion wherein the wearer can manually imprint personal information. The personal information may include such information as a telephone number. Additionally, the imprinted personal information can include emergency contact information. Emergency contact information can be comprised of such information as a person's name, a phone number, an address and combinations thereof.

### DRAWING

In the Drawing:

FIG. 1 depicts the components of the present system including the decal substrate material and an insignia releasably disposed over the substrate material and the insignia which conveys information related to the wearer and a pressure sensitive adhesive over and in register with the insignia and a removable release sheet over the adhesive; and

FIG. 2 illustrates an example embodiment of the system with the insignia decal including a design, verbiage, and a portion provided wherein the wearer can manually imprint personal information.

### DETAILED DESCRIPTION

Disclosed is a system and method which can provide both personal and medical information regarding a traveler by the use of a temporary tattoo. The temporary tattoo can be applied to the wearer's body at an appropriate place to indicate a medical condition needing certain action or personal and emergency contact information. The temporary tattoo may contain verbiage in a language other than the wearer's to convey information to emergency workers in foreign countries.

### Tattoo

For purposes of the detailed disclosure which follows, the term “tattoo” will be used to describe any temporary surface treatment or indication that may be applied to the skin of an individual. A number of temporary tattoo are known to give the appearance of detailed skin or body images without the permanency or pain involved with tattoos. The three major types of substitutes include transferable dye images, painted images, and decal images. Painted images of any quality require the artistic efforts of a painter to provide a good quality image. They are relatively expensive, but provide an infinite variety of high quality images.

Transferable dye images can imitate body tattoos fairly well. Usually water-soluble dyes painted on a substrate in a pattern or image are transferred by wetting the pattern or image and then pressing the wetted dyes against the skin, transferring them to the skin. The dyes are water-soluble and may run and streak easily from perspiration or other liquids. Decal tattoo imitations comprise a printed image on a substrate with an adhesive material on the other side of the substrate.

The term “tattoo” encompasses traditional ink transfer mechanisms, e.g., temporary tattoo systems that utilize transfer sheets and the like, decals, and other image marking devices and systems, as are known in the art. Examples of temporary surface treatments of the types encompassed by the term “tattoo,” as used herein, are disclosed in U.S. Pat. Nos. 4,169,169; 4,175,151; 4,522,864; 4,594,276; 5,601,859; 5,676,401; 5,816,269; 5,958,560; and 6,074,721, the contents of which are hereby incorporated by reference. For example the removable tattoo assembly can be comprised of a laminate, in series, of decal substrate material and a tattoo design or insignia releasably disposed over the substrate material. The tattoo design is designated to eventually be transferred from the substrate material to the skin of the wearer and a pressure-sensitive adhesive is disposed over and in register (i.e., registration) with the tattoo design. Initially a removable release sheet is disposed over the adhesive. The release sheet is preferably transparent so that the tattoo design can be viewed therethrough (in negative). After manual removal of the release sheet from the remainder of the laminate, the tattoo design is adapted to be transferred from the substrate material to the skin of a wearer due to the effects of the pressure-sensitive adhesive intermediate the tattoo design and the wearer's skin. Release of the tattoo design the substrate material is typically promoted by soaking of the exposed outer surface of the substrate material with water, alcohol, or other solvents which facilitate release of the tattoo design from the substrate material.

### Insignia

The system includes a decal substrate material and an insignia releasably disposed over the substrate material. The decal in this embodiment functions as the temporary tattoo applied to the wearer and contains the insignia. The term “insignia” as used herein includes any signage indicating information and includes words, designs, pictures and combinations thereof. Additionally, the term “insignia” is inclusive of the decal.

The insignia conveys information related to the wearer and can be affixed to the wearer's skin using a pressure sensitive adhesive over and in register with the insignia. The insignia may also include verbiage. The term “verbiage” is inclusive of written words conveying a message. In one embodiment the verbiage is not written in English. In a further embodiment the verbiage includes a language foreign to the wearer. Additionally, the verbiage may be in the native language of the country traveled by the wearer of the temporary tattoo.

The insignia may also include information regarding a medical condition of the wearer. This information may be conveyed using symbols or written instructions. In an embodiment, the information is conveyed in a similar way as medical ID bracelets convey the same. The insignia may also include instructions for emergency personal. The insignia information may also include an indication regarding the wearer's nation of origin and/or citizenship

In a further embodiment the temporary tattoo includes a portion wherein the wearer can manually imprint personal information. The information may be imprinted using most any writing instrument or the like. Typically, in an embodiment the ink is substantially resistant to water and is written on the decal or insignia. The personal information may include such information as a telephone number to contact in case of an emergency. Additionally, the imprinted personal information may include emergency contact information other than a phone number. Example emergency contact information may include such information as a person's name, a phone number, an address and combinations thereof.

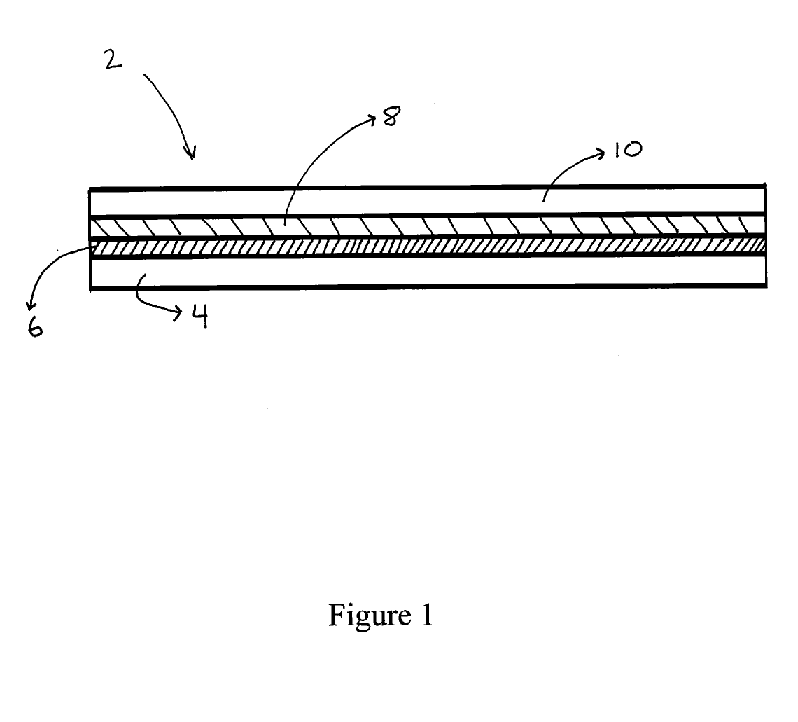

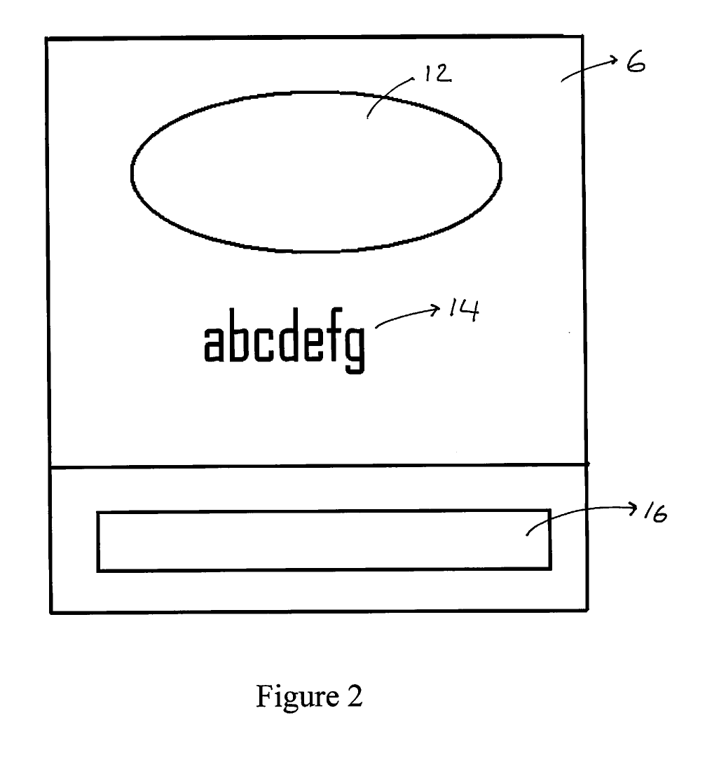

Referring now in greater detail to the drawing in which like numerals indicate like items throughout the several views, FIGS. 1 and 2 depict the present system for providing an informative temporary tattoo to be applied to a wearer's skin when the wearer is traveling to convey information related to the wearer.

FIG. 1 depicts one embodiment of the present system of providing a temporary tattoo for providing information about the wearer of the tattoo. The temporary tattoo assembly 2 includes a decal substrate material 4 and an insignia 6 releasably disposed over the substrate material 4. A pressure sensitive adhesive 8 is included over the insignia 6 and the adhesive 8 is in register with the insignia 6 and a removable release sheet 10 is further included over the adhesive 8.

FIG. 2 is one possible example of the insignia decal 6 including a design 12 and verbiage 14. Additionally shown in FIG. 2 is the portion provided 14 wherein the wearer can manually imprint personal information 16.

While Applicant has set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. A system for providing an informative temporary tattoo to be applied to a wearer's skin when the wearer is traveling to convey information related to the wearer comprising:
a decal substrate material;
an insignia releasably disposed over the substrate material, wherein the insignia conveys information related to the wearer;
a pressure sensitive adhesive over and in register with the insignia; and
a removable release sheet over the adhesive.

2. The system of providing an informative temporary tattoo for a traveler of claim 1, wherein the insignia includes verbiage.

3. The system of providing an informative temporary tattoo for a traveler of claim 2, wherein the verbiage is not English.

4. The system of providing an informative temporary tattoo for a traveler of claim 2, wherein the verbiage includes a language foreign to the wearer.

5. The system of providing an informative temporary tattoo for a traveler of claim 2, wherein the verbiage includes a language native to the land being traveled by the wearer.

6. The system of providing an informative temporary tattoo for a traveler of claim 1, wherein the insignia includes information regarding a medical condition of the wearer.

7. The system of providing an informative temporary tattoo for a traveler of claim 1, wherein the insignia information regarding the wearer indicates a nation of origin for the wearer.

8. The system of providing an informative temporary tattoo for a traveler of claim 1, further including the temporary tattoo providing a portion wherein the wearer can manually imprint personal information.

9. The system of providing an informative temporary tattoo for a traveler of claim 8, wherein the imprinted personal information includes a telephone number.

10. The system of providing an informative temporary tattoo for a traveler of claim 8, wherein the imprinted personal information includes emergency contact information selected from the group consisting of a person's name, a phone number, an address and combinations thereof.

11. The system of providing an informative temporary tattoo for a traveler of claim 1, wherein the insignia includes instructions for emergency personal.

12. A system for providing an informative temporary tattoo to be applied to a wearer's skin when the wearer is traveling to convey information related to the wearer comprising:
a decal substrate material;
an insignia releasably disposed over the substrate material, wherein the insignia conveys information related to the wearer and the insignia includes verbiage written in a language not English;
a pressure sensitive adhesive over and in register with the insignia; and
a removable release sheet over the adhesive.

13. The system of providing an informative temporary tattoo for a traveler of claim 12, wherein the insignia includes information regarding a medical condition of the wearer.

14. The system of providing an informative temporary tattoo for a traveler of claim 1, wherein the insignia includes instructions for emergency personal.

15. The system of providing an informative temporary tattoo for a traveler of claim 12, wherein the verbiage includes a language native to the land being traveled by the wearer.

16. The system of providing an informative temporary tattoo for a traveler of claim 12, further including the temporary tattoo providing a portion wherein the wearer can manually imprint personal information.

17. The system of providing an informative temporary tattoo for a traveler of claim 16, wherein the imprinted personal information includes an address where the wearer is staying when traveling.

18. The system of providing an informative temporary tattoo for a traveler of claim 16, wherein the imprinted personal information includes emergency contact information selected from the group consisting of a person's name, a phone number, an address and combinations thereof.

19. A system for providing an informative temporary tattoo to be applied to a wearer's skin when the wearer is traveling to convey information related to the wearer comprising:
a decal substrate material;
an insignia releasably disposed over the substrate material, wherein the insignia conveys information related to the wearer's medical condition and the insignia providing a portion wherein the wearer can manually imprint personal information
a pressure sensitive adhesive over and in register with the insignia; and
a removable release sheet over the adhesive.

20. The system of providing an informative temporary tattoo for a traveler of claim 19, wherein the insignia includes verbiage not written in English.
